(19) United States
(12) Patent Application Publication
(10) Pub. No.: US 2016/0078496 A1
(43) Pub. Date: Mar. 17, 2016

(54) Determining to Provide Content Based on Location of the Content

(71) Applicant: Google Inc., Mountain View, CA (US)

(72) Inventors: Justin Lewis, Marina del Rey, CA (US); Ruxandra Georgiana Davies, Santa Monica, CA (US)

(21) Appl. No.: 14/486,693

(22) Filed: Sep. 15, 2014

(51) Int. Cl. G06Q 30/02; H04L 29/08

(52) U.S. Cl. CPC G06Q 30/0275; H04L 67/18

(57) ABSTRACT

An example method may include the following operations: receiving a request from a content provider for a content item to incorporate into an output to a computing device, where the request includes one or more elements; identifying candidate content items based on relevance of the one or more elements to the candidate content items; identifying which of the candidate content items are at least partly stored in computer memory; and selecting a candidate content item to satisfy the request, where the selecting is based on relevance of the one or more elements to the candidate content items and on whether the candidate content items are at least partly stored in the computer memory. At least some advantage is given to candidate content items that are at least partly stored in the computer memory when selecting a candidate content item.

### TECHNICAL FIELD

This disclosure relates generally to determining whether or not to provide content for output based on a storage location of the content.

### BACKGROUND

The Internet provides access to a wide variety of resources. For example, content providers serve video, audio, and Web pages over the Internet. These resources present opportunities for other content (e.g., advertisements, or “ads”) to be provided along with the resources. For example, a Web page can include slots in which ads can be presented. The slots can be allocated to other content providers (e.g., advertisers) for the presentation of content.

### SUMMARY

An example method may include the following operations: receiving a request from a content provider for a content item to incorporate into an output to a computing device, where the request includes one or more elements; identifying candidate content items based on relevance of the one or more elements to the candidate content items; identifying which of the candidate content items are at least partly stored in computer memory, where the computer memory is at least one of internal to the computing device or external to the computing device and at a location that is based on a location of the computing device; and selecting a candidate content item to satisfy the request, where the selecting is based on relevance of the one or more elements to the candidate content items and on whether the candidate content items are at least partly stored in the computer memory. At least some advantage is given to candidate content items that are at least partly stored in the computer memory when selecting a candidate content item, and the at least some advantage increases a likelihood that a candidate content item to which the advantage is given will be selected to satisfy the request. At least an identity of the selected candidate content item is output to the content provider. The example method may include one or more of the following features, either alone or in combination.

The selecting operation may include conducting a content auction to determine the candidate content item, where the content auction receives bids from parties associated with the content items; and determining multipliers to apply to the bids, where each multiplier is based on relevance of the one or more elements to a corresponding candidate content item and on whether the corresponding candidate content item is at least partly stored in the computer memory. The multipliers are valued so as to give at least some advantage to candidate content items that are at least partly stored in the computer memory over candidate content items that are not at least partly stored in the computer memory, and the multipliers are applied to the bids in the content auction to affect results of the content auction. The multipliers may be valued so as to give at least some advantage to candidate content items that are wholly stored in the computer memory over candidate content items that are only partly stored in the computer memory or are not stored in the computer memory.

The candidate content items may include online advertisements, and each multiplier may be determined to adjust an effective cost per thousand ad impressions (eCPM) associated with a corresponding online advertisement. The multipliers may be determined so that online advertisements that are at least partly stored in computer memory have larger multipliers than online advertisements that are not stored in computer memory.

The multipliers may be valued so as to give a proportional advantage to candidate content items that are at least partly stored in the computer memory over candidate content items that are not at least partly stored in the computer memory. The proportional advantage for each candidate content item may be based on an amount of the candidate content item that is stored in the computer memory relative to an amount of the candidate content item that is not stored in the computer memory.

The computer memory may be internal to the computing device; and the identifying operation may include searching data stored in one or more servers to identify candidate content items that are at least partly stored in the computer memory. The one or more servers and the computer memory may be at different physical locations.

The computer memory may be external to the computing device, and the method may include selecting one or more servers containing the computer memory, where the selecting is based on a location of the computing device relative to the one or more servers. The identifying may include searching data stored in the one or more servers to identify the candidate content items.

Candidate content items may be stored in both (i) computer memory internal to the computing device and (ii) computer memory that is external to the computing device and at a location that is based on a location of the computing device. More advantage may be given to candidate content items that are stored in the computer memory that is internal to the computing device than to candidate content items that are stored in the computer memory that is external to the computing device.

The example method may include conducting a content auction to determine the candidate content item, where the content auction receives bids and determines the candidate content item based, at least in part on the bids. The method may be performed by a content management system. The content management system, the content provider, and the computing device may be connected to one or more computer networks to enable communication among the content management system, the content provider, and the computing device before, during, and after the content auction.

Features described in this disclosure/specification, including this summary section, can be combined to form implementations not specifically described herein.

The systems and techniques described herein, or portions thereof, can be implemented as a computer program product that includes instructions that are stored on one or more non-transitory machine-readable storage media, and that are executable on one or more processing devices. The systems and techniques described herein, or portions thereof, can be implemented as an apparatus, method, or electronic system that can include one or more processing devices and memory to store executable instructions to implement the stated operations.

The details of one or more implementations are set forth in the accompanying drawings and the description below. Other features, objects, and advantages will be apparent from the description and drawings, and from the claims.

### DESCRIPTION OF THE DRAWINGS

FIG. 1 is a block diagram of an example network environment on which the example processes described herein can be implemented.

FIG. 2 is flowchart showing an example of a process for determining whether or not to provide content for output based on a storage location of the content.

FIG. 3 is a block diagram of a computer system on which the example processes described herein may be performed.

Like reference symbols in the various drawings indicate like elements.

### DETAILED DESCRIPTION

The example systems and processes herein are initially described in the context of online advertising (referred to as an “ad” or “ads”); however, the systems and processes described herein are applicable for use with any appropriate type of online content in any appropriate type of distribution process.

Content, such as advertising, may be provided to network users based, e.g., on demographics, keywords, language, and interests. For example, an ad may be associated with one or more keywords that are stored as metadata along with the ad. An application, such as a video streaming application, may receive input from a user. The input may include a selection of a video and/or one or more keywords associated with the selected video (the keywords may be stored, e.g., as metadata associated with the video). A content management system, which serves ads, may receive the keywords, identify an ad as being associated with one or more of the keywords, and output the ad so that the ad can be presented with video that satisfies the initial request. The video and the ad may be output to, and displayed on, a computing device. When displayed, the ad is incorporated into an appropriate part of the display, e.g., a slot of the video display screen. The user may select the ad by clicking-on the ad. In response, a hyperlink associated with the ad directs the user to another Web page. For example, if the ad is for ABC Travel Company, the Web page to which the user is directed may be the home page for ABC Travel Company. This type of content access is known as click-through. In this context, a “click” is not limited to a mouse click, but rather may include a touch, a programmatic selection, or any other interaction by which the ad may be selected.

A content auction may be run to determine which content is to be output in response to the received keywords or other parameters. In the auction, content providers may bid on specific keywords (which are associated with content). For example, a sporting goods ads provider may associate words such as “baseball”, “football” and “basketball”” with their ads. The content provider may bid on those keywords in the content auction, typically on a cost-per-click (CPC) basis.

The content provider's bid is an amount (e.g., a maximum amount) that the content provider will pay in response to users clicking on their displayed content. So, for example, if a content provider bids five cents per click, then the content provider may pay five cents each time their content is clicked-on by a user, depending upon the type of the auction. In other examples, payment need not be on a cost-per-click (CPC) basis, but rather may be on the basis of other actions (e.g., an amount of time spent on a landing page, a purchase, and so forth). In some example auctions, the winner of the auction pays a price that is based on the amount bid by the runner-up (e.g., the second place finisher) in the auction. This type of auction is known as a second price auction.

Bidding in a content auction typically takes place against other content providers bidding for, e.g., the same keywords. So, for example, if a user selects a video or other content, a content management system may select candidate content items (e.g., ads) from different content providers that are associated with keywords or other parameters (or variants thereof) associated with the selected video. The content auction is then run (e.g., by the content management system) to determine and to select which content (e.g., which ads) to serve along with the video or any other requested content. The winner may be decided, e.g., based on bidding price, relevance of the keywords to content, and other factors.

In some implementations, such as those described herein, the outcome of the content auction is also influenced by whether content (e.g., an advertisement) is stored (e.g., cached) locally. In some implementations, locally-stored content is favored over non-locally-stored content. A reason for this is that there may be less latency associated with providing locally-stored content than with providing non-locally stored content. For example, content that is stored locally can, in some cases, be provided more quickly than content that is not stored locally (assuming all else is equal or about equal). As a result, the content auction may be influenced so that locally-stored content has an advantage over non-locally-stored content. In some implementations, this advantage includes increasing a likelihood that a candidate content item to which the advantage is given will be selected in the content auction to satisfy a request for content. Other factors, in addition to local storage, may also affect the outcome of the content auction.

In some implementations, local storage includes storing at least part of a content item on computer memory of a computing device that made the initial request for content (e.g., for streaming video) and/or storing at least part of a content item in computer memory on a server whose location is selected based on a location of the computing device. For example, the server may be located geographically near to the computing device that made the initial request for content. In other implementations, local storage may include other types and locations of storage.

In an example, streaming video may be requested by a computing device, such as a smartphone. All or part of an advertisement may be stored on memory on the computing device or in memory on a server that is local to the computing device (e.g., in the same time zone, state, city, or other appropriate locale). A user of the computing device may conduct a search for video content (or simply, “a video”) or select a video from a menu. This response is relayed to the video streaming service, which may be implemented in one or more servers or other computing devices. The video streaming service relays one or more keywords and/or other attributes relating to the request or the selection to the content management system. These elements are used by the content management system to conduct an auction to determine which advertisement(s) are to be presented along with the video from the video streaming service.

In this example, the content management system identifies candidate advertisements (candidate content items) based on their relevance to elements relating to the request or the selection of the video content (e.g., keywords, geographic location, demographics, and so forth). The candidate advertisements may be selected based on any appropriate criteria. In some implementations, metadata is stored with each advertisement, and data representing the elements is compared to the metadata. Content items that result in a match, or a match to within an appropriate tolerance, are selected as candidate advertisements.

In this example, the content management system determines which of the candidate advertisement are stored locally relative to the computing device (e.g., that are stored in memory on the computing device or that are stored in memory in one or more servers that are geographically proximate to the computing device). For the candidate advertisements that are stored locally, the content management system adjusts a multiplier associated with those candidate advertisements in the content auction. The multiplier is applied to bids presented in the content auction in order to give those advertisements an advantage over advertisement not stored locally. As a result, assuming all else is equal or near equal (e.g., relevance, geography, and so forth), the content auction will favor selection of a locally-stored advertisement for presentation on the computing device. Other factors, however, may also affect the outcome of the content auction and, therefore, bids associated with locally-stored content may not always win the auction.

In some implementations, a multiplier is associated with each bid in the auction. The multiplier is based on relevance of the elements associated with the request or selection to a corresponding advertisement and on whether the corresponding candidate advertisement is at least partly stored locally. The multipliers are valued so as to give at least some advantage to advertisements that are stored in local memory over those that are not stored in local memory. In an example, the multiplier corresponds to the likelihood that a user will engage with an advertisement. The multiplier may relate to the effective cost per thousand ad impressions (eCPM). When the auction is run, the multiplier is adjusted so that the candidate advertisements have higher multipliers applied to (e.g., multiplied by) bids corresponding to those candidate advertisements. As a result, the eCPMs of the advertisements corresponding to those bids increases, resulting in a higher likelihood of success in the content auction for those advertisement.

The content management system outputs at least the identity of advertisement that wins the content auction to the video streaming service so that the corresponding advertisement can be presented along with (e.g., before) the streaming video. For example, if the advertisement is wholly or partially stored in memory on the computing device, the content management system may send a signal to the streaming service to send to the computing device to instruct the device to begin presentation of the advertisement prior to presentation of the video. Because the advertisement is already stored on the device, latency may be reduced (e.g., the time to download the advertisement may be reduced or eliminated).

As noted above, in some implementations, only part of the advertisement is stored on the computing device. In that case, the part that is not stored may be provided to the computing device along with, or prior to, the streaming video in this example. For implementations where the advertisement is stored locally but external to the computing device, the content management system may instruct output of that content to the streaming service or the computing device for presentation. Because the advertisement is stored locally, latency may be reduced relative to content that is not stored locally.

The example processes described herein may be performed in any appropriate computing environment. An example computing environment on which the processes may be performed includes, but is not limited to, the following.

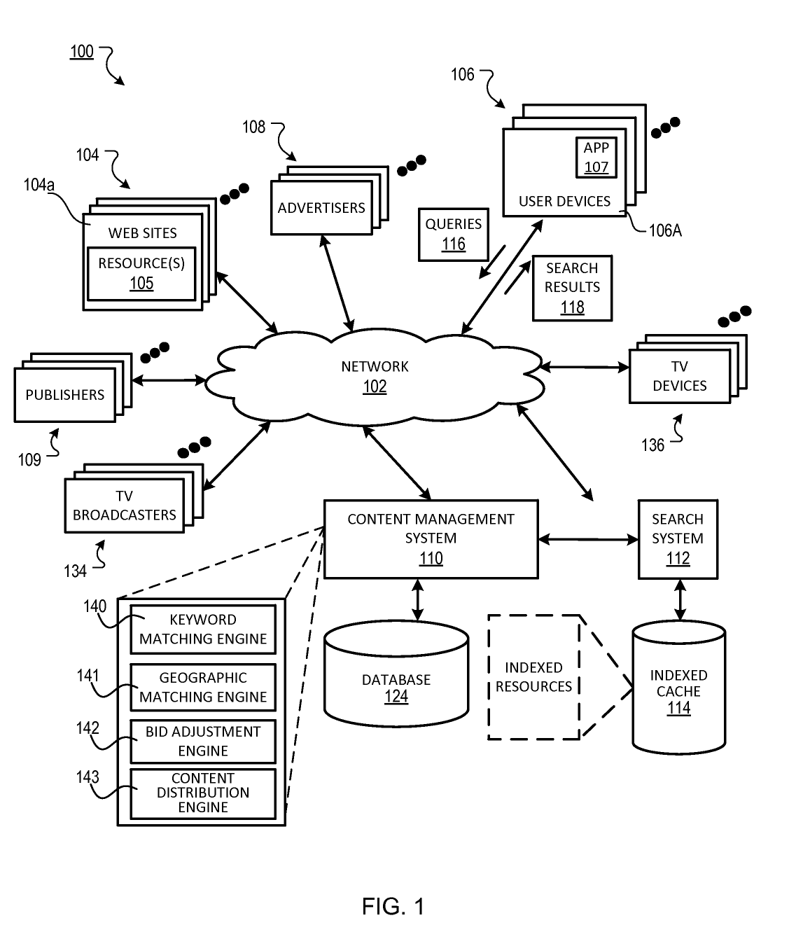

FIG. 1 is a block diagram of an example environment 100 on which the processes described herein may be implemented. Any of the entities of FIG. 1 may be implemented, for example, using one or more servers or processing devices, such as those described with respect to FIG. 1. The designations given to these entities are for illustrative purposes and are non-limiting.

Network 102 can represent a communications network that can allow devices, such as a user device 106a, to communicate with entities on the network through a communication interface (not shown), which can include digital signal processing circuitry. Network 102 can include one or more networks. The network(s) can provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, General Packet Radio System (GPRS), or one or more television or cable networks, among others. For example, the communication can occur through a radio-frequency transceiver. In addition, short-range communication can occur, such as using a Bluetooth®, WiFi®, or other such transceiver.

Network 102 connects various entities, such as Web sites 104, user devices 106, content providers (e.g., advertisers 108), online publishers 109 (e.g., a video streaming service), and a content management system 110. In this regard, example environment 100 can include many thousands of Web sites 104, user devices 106, and content providers (e.g., advertisers 108). Entities connected to network 102 include and/or connect through one or more servers. Each such server can be one or more of various forms of servers, such as a Web server, an application server, a proxy server, a network server, or a server farm. Each server can include one or more processing devices, memory, and a storage system.

Web sites 104 can include one or more resources 105 hosted by one or more servers. An example Web site 104a is a collection of Web pages formatted in hypertext markup language (HTML) that can contain text, images, multimedia content, and programming elements, such as scripts. Each Web site 104 can be maintained by a publisher 109, which may be an entity that controls, manages and/or owns the Web site 104 (on which advertising may be presented).

A resource 105 can be any appropriate data that can be provided over network 102. A resource 105 can be identified by a resource address that is associated with the resource 105. Resources 105 can include HTML pages, word processing documents, portable document format (PDF) documents, images, streaming or other video, and news feed sources, to name a few. Resources 105 can include, but are not limited to, content, such as words, phrases, images and sounds, that can include embedded information (such as meta-information hyperlinks) and/or embedded instructions (such as JavaScript® scripts). Examples of resources also include information about keywords, online video, electronic commerce, or any other subject for which a graphic is generated.

To facilitate searching of resources 105, environment 100 can include a search system 112 (including a search engine) that identifies resources 105 by crawling and indexing the resources 105. Data about resources 105 can be indexed based on the resource to which the data corresponds. The indexed and, optionally, cached copies of resources 105 can be stored in an indexed cache 114.

An example user device 106a is an electronic device that is under control of a user and that is capable of requesting and receiving resources over the network 102. A user device can include one or more processing devices, and can be, or include, a mobile telephone (e.g., a smartphone), a laptop computer, a handheld computer, an interactive or so-called “smart” television or set-top box, a tablet computer, a network appliance, a camera, an enhanced general packet radio service (EGPRS) mobile phone, a media player, a navigation device, an email device, a game console, or a combination of any two or more of these data processing devices or other data processing devices. In some implementations, the user device can be included as part of a motor vehicle.

User device 106a may include/store one or more user applications, such as a Web browser, to facilitate the sending and receiving of data over network 102. A user device 106a that is mobile (or simply, “mobile device”), such as a smartphone or a tablet computer, can include an application (“app”) 107 that allows the user to conduct a network (e.g., Web) search.

User device 106a can request resources 105 from a Web site 104a. For example, the user device can request streaming video from Web site 104a, e.g., by selecting a hyperlink or other item on a Web page corresponding to a particular video. In turn, data representing resource 105 can be provided to the user device 106a for presentation by the user device 106a. User devices 106 can also submit search queries 116 to the search system 112 over the network 102. The search queries may be for one or more videos relating to a particular topic. A request for a resource 105 or a search query 116 sent from a user device 106 can include an identifier, such as a cookie, identifying the user of the user device.

In response to a search query 116, the search system 112 can access the indexed cache 114 to identify resources 105 that are relevant to the search query 116 (e.g., information about keywords). The search system 112 identifies the resources 105 in the form of search results 118 and returns the search results 118 to a user device 106 in search results pages. A search result 118 can include data generated by the search system 112 that identifies a resource 105 that is responsive to a particular search query 116. For example, the search results page may include a list of videos that satisfy the request, with hyperlinks thereto.

Content management system 110 can be used for selecting and providing content (e.g., ads, video, and so forth) in response to requests for content. Content management system 110 also can, with appropriate user permission, update database 124 based on activity of a user. The user may enable and/or disable the storing of such information. With appropriate user permission obtained beforehand, database 124 can store a profile for the user. In some implementations, the information in database 124 can be derived, for example, from one or more of a query log, an advertisement log, or requests for content.

Content management system 110 may include a keyword matching engine 140 to compare query keywords to content keywords and to generate a keyword matching score indicative of how well the query keywords match the content keywords. In an example, the keyword matching score is equal, or proportional, to a sum of a number of matches of words in an input query to words associated with the content. Content management system 110 may include a geographic (or “geo-”) matching engine 141 to compare geographic information (e.g., numerical values for place names) obtained based on input queries to geographic information associated with content. Content management system 110 may also include other engines (not shown) for matching input demographics to desired demographics of an advertising campaign, for identifying Web pages or other distribution mechanisms based on content, and so forth.

When a resource 105 or search results 118 are requested by a user device 106, content management system 110 can receive a request for content (e.g., advertising) to be provided with resource 105 or search results 118. The request for content can include characteristics of one or more “slots” that are defined for the requested resource 105 or search results page. For example, data representing resource 105 can include data specifying a portion of resource 105 or a portion of a user display, such as a presentation location of a pop-up window or a slot of a third-party content site or Web page, in which content can be presented. An example slot is an ad slot. Search results pages can also include one or more slots in which other content items (e.g., ads) can be presented.

Information about slots can be provided to content management system 110. For example, a reference (e.g., URL) to the resource for which the slot is defined, a size of the slot, and/or media types that are available for presentation in the slot can be provided to the content management system 110. Similarly, keywords associated with a requested resource (e.g., streaming video) or search query can also be provided to the content management system 110 to facilitate identification of content that is relevant to the resource or search query 116.

Based at least in part on data generated from and/or included in the request, content management system 110 can select content that is eligible to be provided in response to the request (referred to as “candidate content items”). For example, candidate content items can include eligible ads having characteristics matching keywords, geographic information, demographic information, known interests, etc. associated with corresponding content. In some implementations, the universe of candidate content items (e.g., ads) can be narrowed by taking into account other factors, such as previous search queries 116. For example, content items corresponding to historical search activities of the user (obtained with appropriate prior permission of the user) including, e.g., search keywords used, particular content interacted with, sites visited by the user, etc. can also be used in the selection of candidate content items by content management system 110.

Content management system 110 can select the candidate content items that are to be provided for presentation in slots of a resource 105 or search results page 118 based, at least in part, on results of an auction, such as a second price auction. For example, for candidate content items, content management system 110 can receive bids from content providers (e.g., advertisers 108) and allocate slots, based at least in part on the received bids (e.g., based on the highest bidders at the conclusion of the auction). The bids are amounts that the content providers are willing to pay for presentation (or selection) of their content with a resource 105 or search results page 118. For example, a bid for keywords can specify an amount that a content provider is willing to pay for each 2000 impressions (e.g., presentations) of the content item, referred to as a CPM bid. Alternatively, the bid for keywords can specify an amount that the content provider is willing to pay for a selection (e.g., a click-through) of the content item or a conversion following selection of the content item. This is referred to as cost-per-click (CPC). In some implementations, the selected content items are determined based on the bid of each bidder adjusted by a multiplier, as described herein.

In some implementations, TV (Television) broadcasters 134 produce and present television content on TV user devices 136, where the television content can be organized into one or more channels. TV broadcasters 134 can include, along with the television content, one or more content slots in which other content (e.g., advertisements) can be presented. For example, a TV network can sell slots of advertising to advertisers in television programs that they broadcast. Some or all of the content slots can be described in terms of user audiences which represent typical users who watch content with which a respective content slot is associated. Content providers can bid, in an auction (as described above), on a content slot that is associated with keywords for particular television content.

Content management system 110 may include bid adjustment engine 142. Bid adjustment engine 142 may include executable code to implement at least part of the example processes described herein including, but not limited to, example process 200. Content selected for output may be distributed by content distribution engine 143, which is also part of the content management system.

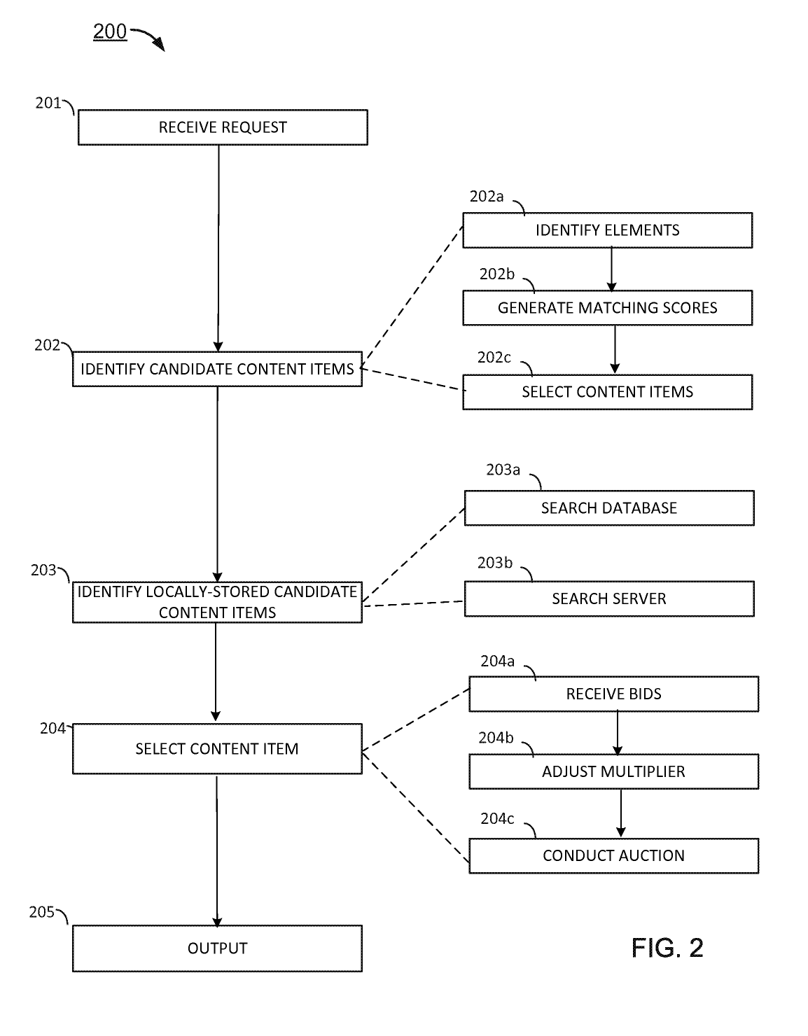

FIG. 2 is a flowchart showing an example of a process 200 for determining whether or not to provide content for output based on a storage location of the content. In some implementations, process 200 may be performed by bid adjustment engine 142 in conjunction with other functions implemented by the content management system and the search system described above. In some implementations, process 200 may be triggered in response to a specific user request e.g., searching for an online video or other appropriate content. In some other implementations, process 200 may be triggered in response to an event, such as clicking on an online video or other appropriate content for viewing.

According to process 200, a request is received for a content item. For example, a user may conduct a search of an online video service (e.g., a streaming video service), and select a video to play. In response to the search and/or selection, data may be sent from the user's computer to a server that hosts the online video service (e.g., that hosts resource 105 of FIG. 1). The data may include information pertaining to the user's search and/or selection and, with appropriate permission, information about the user. For example, the data may represent keywords that were part of the user's search, interests of the user (as obtained, with user permission, from a user profile or elsewhere), metadata associated with a link that enabled the selection, and so forth. The server that hosts the video service may include additional content along with the requested video. For example, the server may include online advertising with the content (e.g., the streaming video). To obtain this online advertising, the server may communicate with the content management system 110 over network 102 (see, e.g., FIG. 1).

For example, in some implementations, the hosting server may send a request to the content management system. The request may be received (201) (e.g., by the content management system) and a response thereto may be generated. For example, candidate content items may be identified (202). The candidate content items may include content items that have some degree of relevance to the request. For example, the candidate content items may include, e.g., online advertising or any other appropriate content that may be included with the streaming video (e.g., video trailers, related content, and so forth).

In some implementations, to determine relevance of content items, and thus which content items will qualify as candidate content items, elements related to the request or the selection of the video content are identified (202a). For example, the content management system may identify elements related to the request or the selection. In some implementations, the elements in the request may include keywords that were input part of a search, interests of the user (as obtained from a user profile or elsewhere), metadata associated with a link that enabled selection of the video content, geographical location, demographics, and so forth. The elements may include any appropriate data that may be used to identify relevance of content.

A matching score may be generated (202b) based on elements in the request and elements associated with candidate content items. The matching score may be indicative of a degree of relevance of the elements in the request to candidate content items. In some implementations, the content management system generates the matching score based on elements (e.g., keywords, metadata, etc.) associated with content items and elements associated with the request. For example, the content management system may execute one or more processes to determine scores that indicate the extent to which the elements in the available content items match the elements in the request for content.

The matching scores may be used to select (202c) candidate content items that are relevant to the request. In some implementations, the relevant content items may be determined by comparing the matching scores to a threshold value and selecting as the relevant content items, content items that at least meet the threshold value. In some implementations, the higher the matching score is, the more there is match between the corresponding content and the request. Candidate content items having matching scores that exceed the threshold may be selected. In some implementations, processes other than those described herein may be used to identify, and to select, candidate content items.

According to process 200, candidate content items that are stored locally, in whole or in part, are identified (203) from among the candidate content items. For example, candidate content items that are at least partly stored in local computer memory are identified. In some implementations, the local computer memory may be internal to the computing device (e.g., the computer's hard drive) or external to the computing device and at a location that is based on a location of the computing device. For example, the computer memory may be in an external server that is geographically local to the computing device that made the initial request for content. For example, the server may be within the same building, block, city, state, geographic area, country, and so forth as the requesting computing device. In other implementations, local storage may include other types and locations of storage.

Locally-stored candidate content items may be more quickly accessible to the user's computer than candidate content items that are stored at other geographic locations (e.g., at geographic locations outside of the predefined geographic proximity). Accordingly, locally-stored candidate content items may be given an advantage during a content auction that is run to determine which content to serve, as described in more detail below.

In some implementations, all or part of a candidate content item may be stored in memory on, or accessible to, the computing device used to send the initial request. The identities of candidate content items that are stored on a computing device may be maintained in a database (e.g., in a list) that is stored in one or more servers, and that is accessible to the content management system. This information may be updated as new content items are stored in the computer memory. Candidate content items that are stored in this local memory may be identified (203b) by requesting, or conducting, a search of this database. For example, the content management system may send the request to search the database or, in appropriate circumstances, conduct the search itself.

In some implementations, all or part of a candidate content item may be stored in memory on, or accessible to, one or more server(s) that are local to the computing device used to send the initial request. Candidate content items that are stored on the local server(s) may be identified (203b) by requesting, or conducting, a search of the storage in the one or more servers. For example, the content management system may send the request to search the server(s) or, in appropriate circumstances, conduct the search itself.

According to process 200, one or more of the candidate content items (e.g., advertisements) are selected (204) to be displayed along with the video content requested by the user. A content auction may be run to select a content item for display from among the identified candidate content items. For example, the content management system or another entity may run the content auction.

According to process 200, in the auction, bids are received (204a) from content providers that bid, for example, on the same keywords in an auction. In this example, the content items that are participating in the auction include the identified candidate content items, which include content items that are stored locally relative the computing device that initiated the request and content items that are not stored locally relative to that computing device. The content item that wins the auction may be selected for display, or selected for display at a preferred location along with the video content. Other content items, such as runners-up in the auction, may also be selected for display at less preferred locations.

According to process 200, in the example auction, each bid has an associated effective cost per thousand ad impressions (eCPM), and an associated multiplier that is applied to each bid to vary that eCPM. In some implementations, the multiplier is a number that is selected to reflect the likelihood of a user engaging with a content item, and is applied to each bid to weight that bid based on the likelihood of the user engaging with a content item. In some implementations, the multipliers are valued so as to give a proportional advantage, in the auction, to candidate content items that are at least partly stored locally over candidate content items that are not at least partly stored locally. As explained above, in some examples, “local” storage may include storage on the computing device that issued the initial request or in memory on one or more servers based on their geographic proximity to the computing device that issued the initial request.

In some implementations, the eCPM multiplier is adjusted (204b) to account for local storage of all or part of a candidate content item. For example, the multiplier is adjusted so that bids associated with locally-stored content items are at least partly favored over bids associated with content items that are not locally stored. The effect of the multiplier may not be dispositive, however, since other factors (e.g., relevance of the content item) may affect the auction results. As explained above, in some cases, there may be less latency (e.g., less delay due to downloading time) associated with providing locally-stored content than with providing non-locally-stored content. For example, content that is stored locally can, in some cases, be provided or downloaded more quickly than content that is not stored locally. In some implementations, if the content is stored locally on a computing device, no download may be necessary, and the content can be provided (e.g., advertising can be displayed) without incurring download delays.

In some implementations, part of the content may be stored in memory that is on, or accessible to, the computing device that initiated the request and another part of the content may be stored on a server that is local to the computing device or that is not local to the computing device. In some implementations, part of the content may be stored on a server that is local to the computing device and another part of the content may be stored on a server that is not local to the computing device. In these example implementations, the latency may be reduced by beginning display with the part of the content that is stored locally, and then downloading the remaining content during display of the prior portion.

In some implementations, the multipliers are valued (e.g., adjusted) so as to give at least some advantage to candidate content items that are wholly stored locally over candidate content items that are only partly stored locally. For example, an advertisement that is completely stored locally may have less latency than an advertisement that is partly stored locally (at least because, in some cases, the part that is not stored locally may have a delay due to downloading). Accordingly, the multipliers may be valued to favor content that is wholly stored locally rather than content that is partly stored locally. In some implementations, the multipliers may be valued to favor content that is wholly stored on a local computing device rather than content that is partly on the computing device and partly stored on a local or non-local server. The reasoning is the same in this example, e.g., there may be less latency for content on the local computing device than for content stored on a local or non-local server. In some implementations, the multipliers may be valued so as to give at least some advantage to candidate content items that are at least partly stored locally over candidate content items that are not at least partly stored locally.

In some implementations, the multipliers are valued so as to give a proportional advantage to candidate content items that are at least partly stored locally over candidate content items that are not at least partly stored locally. For example, the proportional advantage for each candidate content item may be based on an amount of the candidate content item that is stored locally relative to an amount of the candidate content item that is not stored locally. For example, if a first content item is fully stored in local computer memory, the multiplier of such a content item may be increased by a relatively large factor. For a second content item, if half of the content is stored in local computer memory and the other half is stored elsewhere, the multiplier may be decreased by half, and so forth. In some implementations, the value of the multiplier may be varied based on whether the other half of the content is stored on a server that is local to the computing device versus whether the content is stored on a server that is not local to the computing device. For example, the value of the multiplier may be greater if the content is stored on a local server than if the content is stored on a server that is not local (since, in some cases, there is less latency for the local server).

In some implementations, the multipliers are valued to give additional advantage to candidate content items that are stored in computer memory that is internal to the computing device than to candidate content items that are stored in the computer memory that is external to the computing device, such as on a local server. This is because there may be less latency for the content coming from the local memory (since there is little or no latency resulting from server download).

According to process 200, the multipliers are applied to (e.g., multiplied by) the bids and the content auction (204c) is conducted (e.g., by the content management system) to select which of the candidate content items to serve along with the streaming video or any other requested content. As part of the auction process, the eCPM multipliers are valued, as described above, to give those content items that are stored locally an advantage over content items not stored locally. In some implementations, when the auction is run, each multiplier is adjusted so that the stored candidate content items (e.g., advertisements) have higher multipliers applied to (e.g., multiplied by) bids corresponding to those candidate content items. As a result, the eCPMs of the advertisements corresponding to those bids increase, resulting in a higher likelihood of success in the content auction for those advertisements. While the multipliers may cause the content auction to favor the selection of a locally stored content item, other factors may affect the outcome of the content auction, causing non-local content items to be selected.

In some implementations, the content management system selects a winner of the content auction based on the multiplier-adjusted bids (e.g., the highest bid may win). Data representing the winning content item is output (205) to the computing device that initiated the request (201). For example, the data may identify the winning content item and include an instruction to the online video service to instruct the computing device that initiated the request to begin playing local content at an appropriate time. In some implementations, the data may identify the winning content item, and inform the online video service of the identity of one or more local servers on which that winning content is stored, and from which that winning content can be downloaded for presentation along with the video content. In some implementations, as described above, only part of the winning content may be stored locally (e.g., on the computing device or local server). In these examples, the location of any non-local content may also be identified, from which the non-local content can be downloaded. In some implementations, the content management system may provide at least part of the non-local content to the online video service, along with instructions about where the local content is stored.

In more detail, in a case where the content is stored in local memory, in this example, the online video service instructs the computing device when to play the content (e.g., a video advertisement), and also provides the requested video at the appropriate time. In a case where only part of content is stored in local memory, in this example, the online video service instructs the computing device when to play that part of the content (e.g., a video advertisement), and also provides the remaining part of the content to the computing device along with the requested video. In a case where the content is stored in a local server, in this example, the online video service retrieves that content from the local server, and provides the content to the computing device along with instructions about when to play that the content (e.g., a video advertisement), along with the requested video. In a case where only part of the content is stored in a local server, in this example, the online video service retrieves that part of the content from the local server, and also provides the remaining part of the content to the computing device along with the requested video. The remaining part of the content may be obtained from one or more non-local sources, e.g., servers or the like. Other scenarios are also possible depending upon where content is stored and how much is stored. For example, parts of content may be stored in more than two locations, in which case the instructions about how to obtain that content would vary.

In some implementations, rather than providing instructions to the online video service (or whatever program is requesting content), the instructions may be provided directly to a browser on the user's computing device. Executable code running on the browser may perform the foregoing functions based on the received instructions.

The processes described herein are not limited to use in the example contexts described above, but rather may be used in any appropriate context to display information about any appropriate subject matter.

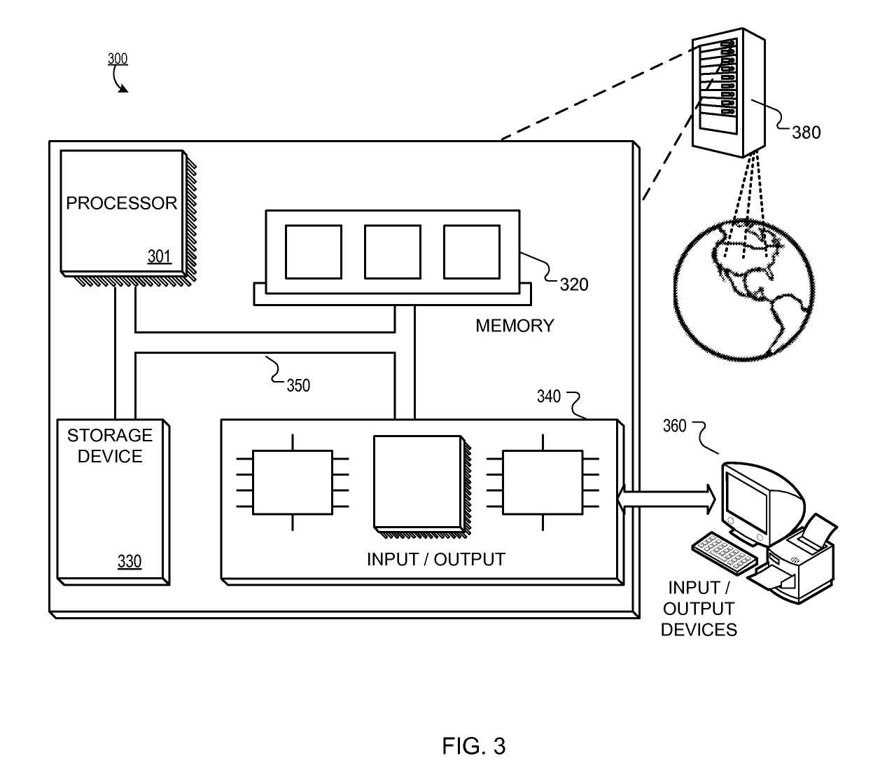

FIG. 3 is block diagram of an example computer system 300 that may be used in performing the processes described herein (e.g., processes 200 and 600). System 300 includes a processor 310, a memory 320, a storage device 330, and an input/output device 340. Each of components 310, 320, 330, and 340 can be interconnected, for example, using a system bus 350. The processor 310 is capable of processing instructions for execution within the system 300. In one implementation, processor 310 is a single-threaded processor. In another implementation, the processor 310 is a multi-threaded processor. The processor 310 is capable of processing instructions stored in the memory 320 or on the storage device 330.

The memory 320 stores information within the system 300. In one implementation, the memory 320 is a computer-readable medium. In one implementation, the memory 320 is a volatile memory unit. In another implementation, the memory 320 is a non-volatile memory unit.

The storage device 330 is capable of providing mass storage for the system 300. In one implementation, the storage device 330 is a computer-readable medium. In various different implementations, the storage device 330 can include, for example, a hard disk device, an optical disk device, or some other large capacity storage device.

The input/output device 340 provides input/output operations for the system 300. In one implementation, the input/output device 340 can include one or more of a network interface devices, e.g., an Ethernet card, a serial communication device, e.g., an RS-232 port, and/or a wireless interface device, e.g., and 802.11 card. In another implementation, the input/output device can include driver devices configured to receive input data and send output data to other input/output devices, e.g., keyboard, printer and display devices 360.

The web server, advertisement server, and impression allocation module can be realized by instructions that upon execution cause one or more processing devices to carry out the processes and functions described above. Such instructions can comprise, for example, interpreted instructions, such as script instructions, e.g., JavaScript® or ECMAScript instructions, or executable code, or other instructions stored in a computer readable medium. The web server and advertisement server can be distributively implemented over a network, such as a server farm, or can be implemented in a single computer device.

Example computer system 300 is depicted as a rack in a server 380 in this example. As shown the server may include multiple such racks. Various servers, which may act in concert to perform the processes described herein, may be at different geographic locations, as shown in the figure. The processes described herein may be implemented on such a server or on multiple such servers. As shown, the servers may be provided at a single location or located at various places throughout the globe. The servers may coordinate their operation in order to provide the capabilities to implement the processes.

Although an example processing system has been described in FIG. 3, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

In this regard, various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Content, such as ads and GUIs, generated according to the processes described herein may be displayed on a computer peripheral (e.g., a monitor) associated with a computer. The display physically transforms the computer peripheral. For example, if the computer peripheral is an LCD display, the orientations of liquid crystals are changed by the application of biasing voltages in a physical transformation that is visually apparent to the user. As another example, if the computer peripheral is a cathode ray tube (CRT), the state of a fluorescent screen is changed by the impact of electrons in a physical transformation that is also visually apparent. Moreover, the display of content on a computer peripheral is tied to a particular machine, namely, the computer peripheral.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating monetizable parameters (e.g., monetizable demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

Elements of different implementations described herein can be combined to form other implementations not specifically set forth above. Elements can be left out of the processes, computer programs, etc. described herein without adversely affecting their operation. In addition, the logic flows depicted in the figures do not require the particular order shown, or sequential order, to achieve desirable results. Various separate elements can be combined into one or more individual elements to perform the functions described herein.

Other implementations not specifically described herein are also within the scope of the following claims.

What is claimed is:

1. A method comprising:
receiving, by one or more processing devices, a request from a content provider for a content item to incorporate into an output to a computing device, the request comprising one or more elements;
identifying, by the one or more processing devices, candidate content items based on relevance of the one or more elements to the candidate content items;
identifying, by the one or more processing devices, which of the candidate content items are at least partly stored in computer memory, the computer memory being at least one of internal to the computing device or external to the computing device and at a location that is based on a location of the computing device;
selecting, by the one or more processing devices, a candidate content item to satisfy the request, the selecting being based on relevance of the one or more elements to the candidate content items and on whether the candidate content items are at least partly stored in the computer memory, the one or more processing devices giving at least some advantage to candidate content items that are at least partly stored in the computer memory when selecting a candidate content item, the at least some advantage increasing a likelihood that a candidate content item to which the advantage is given will be selected to satisfy the request; and
outputting, by the one or more processing devices, at least an identity of the selected candidate content item to the content provider.

2. The method of claim 1, wherein selecting comprises:
conducting, by the one or more processing devices, a content auction to determine the candidate content item, the content auction receiving bids from parties associated with the content items; and
determining, by the one or more processing devices, multipliers to apply to the bids, each multiplier being based on relevance of the one or more elements to a corresponding candidate content item and on whether the corresponding candidate content item is at least partly stored in the computer memory, the multipliers being valued so as to give at least some advantage to candidate content items that are at least partly stored in the computer memory over candidate content items that are not at least partly stored in the computer memory;
wherein the multipliers are applied to the bids in the content auction to affect results of the content auction.

3. The method of claim 2, wherein the multipliers are valued so as to give at least some advantage to candidate content items that are wholly stored in the computer memory over candidate content items that are only partly stored in the computer memory or are not stored in the computer memory.

4. The method of claim 2, wherein the candidate content items comprise online advertisements, and each multiplier is determined to adjust an effective cost per thousand ad impressions (eCPM) associated with a corresponding online advertisement, the multipliers being determined so that online advertisements that are at least partly stored in computer memory have larger multipliers than online advertisements that are not stored in computer memory.

5. The method of claim 2, wherein the multipliers are valued so as to give a proportional advantage to candidate content items that are at least partly stored in the computer memory over candidate content items that are not at least partly stored in the computer memory, the proportional advantage for each candidate content item being based on an amount of the candidate content item that is stored in the computer memory relative to an amount of the candidate content item that is not stored in the computer memory.

6. The method of claim 1, wherein the computer memory is internal to the computing device; and
wherein identifying comprises searching, by the one or more processing devices, data stored in one or more servers to identify candidate content items that are at least partly stored in the computer memory, the one or more servers and the computer memory being at different physical locations.

7. The method of claim 1, wherein the computer memory is external to the computing device, and the method further comprises:
selecting, by the one or more processing devices, one or more servers containing the computer memory, the selecting being based on a location of the computing device relative to the one or more servers;
wherein identifying comprises searching, by the one or more processing devices, data stored in the one or more servers to identify the candidate content items.

8. The method of claim 1, wherein candidate content items are stored in both (i) computer memory internal to the computing device and (ii) computer memory that is external to the computing device and at a location that is based on a location of the computing device; and
wherein the one or more processing devices give more advantage to candidate content items that are stored in the computer memory that is internal to the computing device than to candidate content items that are stored in the computer memory that is external to the computing device.

9. The method of claim 1, further comprising:
conducting, by the one or more processing devices, a content auction to determine the candidate content item, the content auction receiving bids and determining the candidate content item based, at least in part on the bids;
wherein the method is performed by a content management system, and wherein the content management system, the content provider, and the computing device are connected to one or more computer networks to enable communication among the content management system, the content provider, and the computing device before, during, and after the content auction.

10. A system comprising:
memory storing instructions that are executable; and
one or more processing devices to execute the instructions to perform operations comprising:
receiving, by the one or more processing devices, a request from a content provider for a content item to incorporate into an output to a computing device, the request comprising one or more elements;
identifying, by the one or more processing devices, candidate content items based on relevance of the one or more elements to the candidate content items;
identifying, by the one or more processing devices, which of the candidate content items are at least partly stored in computer memory, the computer memory being at least one of internal to the computing device or external to the computing device and at a location that is based on a location of the computing device;
selecting, by the one or more processing devices, a candidate content item to satisfy the request, the selecting being based on relevance of the one or more elements to the candidate content items and on whether the candidate content items are at least partly stored in the computer memory, the one or more processing devices giving at least some advantage to candidate content items that are at least partly stored in the computer memory when selecting a candidate content item, the at least some advantage increasing a likelihood that a candidate content item to which the advantage is given will be selected to satisfy the request; and
outputting, by the one or more processing devices, at least an identity of the selected candidate content item to the content provider.

11. The system of claim 10, wherein selecting comprises:
conducting, by the one or more processing devices, a content auction to determine the candidate content item, the content auction receiving bids from parties associated with the content items; and
determining, by the one or more processing devices, multipliers to apply to the bids, each multiplier being based on relevance of the one or more elements to a corresponding candidate content item and on whether the corresponding candidate content item is at least partly stored in the computer memory, the multipliers being valued so as to give at least some advantage to candidate content items that are at least partly stored in the computer memory over candidate content items that are not at least partly stored in the computer memory;
wherein the multipliers are applied to the bids in the content auction to affect results of the content auction.

12. One or more non-transitory machine-readable storage media storing instructions that are executable by one or more processing devices to perform operations comprising:
receiving a request from a content provider for a content item to incorporate into an output to a computing device, the request comprising one or more elements;
identifying candidate content items based on relevance of the one or more elements to the candidate content items;
identifying which of the candidate content items are at least partly stored in computer memory, the computer memory being at least one of internal to the computing device or external to the computing device and at a location that is based on a location of the computing device;
selecting a candidate content item to satisfy the request, the selecting being based on relevance of the one or more elements to the candidate content items and on whether the candidate content items are at least partly stored in the computer memory, the one or more processing devices giving at least some advantage to candidate content items that are at least partly stored in the computer memory when selecting a candidate content item, the at least some advantage increasing a likelihood that a candidate content item to which the advantage is given will be selected to satisfy the request; and
outputting at least an identity of the selected candidate content item to the content provider.

13. The one or more non-transitory machine-readable storage media of claim 12, wherein selecting comprises:
conducting a content auction to determine the candidate content item, the content auction receiving bids from parties associated with the content items; and
determining multipliers to apply to the bids, each multiplier being based on relevance of the one or more elements to a corresponding candidate content item and on whether the corresponding candidate content item is at least partly stored in the computer memory, the multipliers being valued so as to give at least some advantage to candidate content items that are at least partly stored in the computer memory over candidate content items that are not at least partly stored in the computer memory; and
wherein the multipliers are applied to the bids in the content auction to affect results of the content auction.

14. The one or more non-transitory machine-readable storage media of claim 13, wherein the multipliers are valued so as to give at least some advantage to candidate content items that are wholly stored in the computer memory over candidate content items that are only partly stored in the computer memory or are not stored in the computer memory.

15. The one or more non-transitory machine-readable storage media of claim 13, wherein the candidate content items comprise online advertisements, and each multiplier is determined to adjust an effective cost per thousand ad impressions (eCPM) associated with a corresponding online advertisement, the multipliers being determined so that online advertisements that are at least partly stored in computer memory have larger multipliers than online advertisements that are not stored in computer memory.

16. The one or more non-transitory machine-readable storage media of claim 13, wherein the multipliers are valued so as to give a proportional advantage to candidate content items that are at least partly stored in the computer memory over candidate content items that are not at least partly stored in the computer memory, the proportional advantage for each candidate content item being based on an amount of the candidate content item that is stored in the computer memory relative to an amount of the candidate content item that is not stored in the computer memory.

17. The one or more non-transitory machine-readable storage media of claim 12, wherein the computer memory is internal to the computing device; and
wherein identifying comprises searching data stored in one or more servers to identify candidate content items that are at least partly stored in the computer memory, the one or more servers and the computer memory being at different physical locations.

18. The one or more non-transitory machine-readable storage media of claim 12, wherein the computer memory is external to the computing device, and wherein the operations comprise selecting one or more servers containing the computer memory, the selecting being based on a location of the computing device relative to the one or more servers; and
wherein identifying comprises searching, by the one or more processing devices, data stored in the one or more servers to identify the candidate content items.

19. The one or more non-transitory machine-readable storage media of claim 12, wherein candidate content items are stored in both (i) computer memory internal to the computing device and (ii) computer memory that is external to the computing device and at a location that is based on a location of the computing device; and
wherein the one or more processing devices give more advantage to candidate content items that are stored in the computer memory that is internal to the computing device than to candidate content items that are stored in the computer memory that is external to the computing device.

20. The one or more non-transitory machine-readable storage media of claim 12, wherein the operations comprise conducting, by the one or more processing devices, a content auction to determine the candidate content item, the content auction receiving bids and determining the candidate content item based, at least in part on the bids; and
wherein the one or more non-transitory machine-readable storage media are part of a content management system, and wherein the content management system, the content provider, and the computing device are connected to one or more computer networks to enable communication among the content management system, the content provider, and the computing device before, during, and after the content auction.
